(19) United States
(12) Patent Application Publication
(10) Pub. No.: US 2004/0252122 A1
(43) Pub. Date: Dec. 16, 2004

(54) Methods and apparatus to control display attributes of characters in a pre-boot environment

(76) Inventors: Michael A. Rothman, Gig Harbor, WA (US); Vincent J. Zimmer, Federal Way, WA (US)

Correspondence Address: GROSSMAN & FLIGHT LLC, Suite 4220, 20 North Wacker Drive, Chicago, IL, 60606-6357, US

(21) Appl. No.: 10/458,872

(22) Filed: Jun. 11, 2003

(51) Int. Cl. G06T 11/00

(52) U.S. Cl. 345/467

(57) ABSTRACT

Methods and apparatus to control display attributes of characters in a pre-boot environment are described herein. In an example method, a glyph associated with a character of a string is retrieved based on glyph information embedded in the string to display the character in a local console. Accordingly, the glyph is displayed on the local console. Prior to transmitting the string for display on a remote console, the glyph information is removed from the string.

### TECHNICAL FIELD

The present disclosure relates generally to firmware, and more particularly, to methods and apparatus to control display attributes of characters in a pre-boot environment.

### BACKGROUND

In information technology, a glyph is a graphical representation that provides the appearance or form of a character. A glyph may be alphabetic, numeric or some other symbol representative of a character. A collection of glyphs of a certain style may be considered a font. One of the more prevalent encoding formats for text files in computers and on the Internet is American Standard Code for Information Interchange (ASCII). In the ASCII character set, each alphabetic, numeric, or special character is represented by a 7-bit binary number (i.e., a string of seven 0s and 1s). For example, UNIX® and Disk Operating System (DOS) based operating systems use ASCII for text files.

The ASCII character set is a subset of the American National Standards Institute (ANSI) character set. In particular, the characters in the ASCII character set are the same as the first 128 characters (numbers 0 through 127) of the ANSI character set. The ANSI character set employs an 8-bit binary number to represent each character and, therefore, the ANSI character set represents up to 256 characters (numbers 0 through 255). However, the ANSI character set is insufficient for non-Latin based languages such as Chinese, Japanese, and Korean. That is, characters in such languages cannot be displayed by some applications using the ANSI character set. As a result, non-Latin based characters may be represented on an output device as solid blocks (▪), question marks (?), graphical representations of a smiley face ( [symbol] ), and/or other graphical representations of unknown characters.

To support worldwide interchange, processing, and display of written text or script in all languages, the Unicode Worldwide Character Standard (hereinafter “Unicode standard”) is used. The Unicode standard is a character coding system that encodes characters regardless of the platform (e.g., Windows XP®, Mac OS X, Unix, etc.), the program (e.g., Microsoft® Word, Wordperfect, etc.), or the language (e.g., English, Chinese, etc.). In contrast to the ANSI character set that uses a single byte (i.e., 8 bits) to represent each character, the Unicode standard uses two bytes (i.e., 16 bits) to represent each character and can, therefore, represent 65,536 characters. For example, the ANSI character “A” may be represented in hexadecimal notation by the single byte 41h, and the Unicode character “A” may be represented in hexadecimal notation by a two-byte string 41h, 00h. The 256-character limit of the ANSI character set supports only a few international characters, such as accented French and German vowels whereas the 65,536-character limit of the Unicode standard supports virtually every character of every alphabet in the world.

Demand for support of non-Latin based languages, such as Chinese, Japanese, and Korean, in different applications is increasing. In particular, characters of various languages or alphabets have different widths. Without a uniform standard among platform designers, independent basic input/output system (BIOS) vendors (IBVs), independent software vendors (ISVs), independent hardware vendors (IHVs), operating system vendors (OSVs), and/or original equipment manufacturers (OEMs), however, control of the width of specific characters to better support a proportional look and feel associated with strings containing a mix of narrow and wide characters may be difficult.

### BRIEF DESCRIPTION OF THE DRAWINGS

FIG. 1 is a block diagram representation of an example processor system.

FIG. 2 is a block diagram representation of an alternative example processor system.

FIG. 3 is a block diagram representation of an example string file.

FIG. 4 is a block diagram representation of an example string processed for a local console.

FIG. 5 is a block diagram representation of an example string processed for a remote console.

FIG. 6 is a flow diagram representation of example machine readable instructions that may control display attributes of characters in a pre-boot environment.

### DETAILED DESCRIPTION

Although the following discloses example systems including, among other components, software or firmware executed on hardware, it should be noted that such systems are merely illustrative and should not be considered as limiting. For example, it is contemplated that any or all of the disclosed hardware, software, and/or firmware components could be embodied exclusively in hardware, exclusively in software, exclusively in firmware or in some combination of hardware, software, and/or firmware.

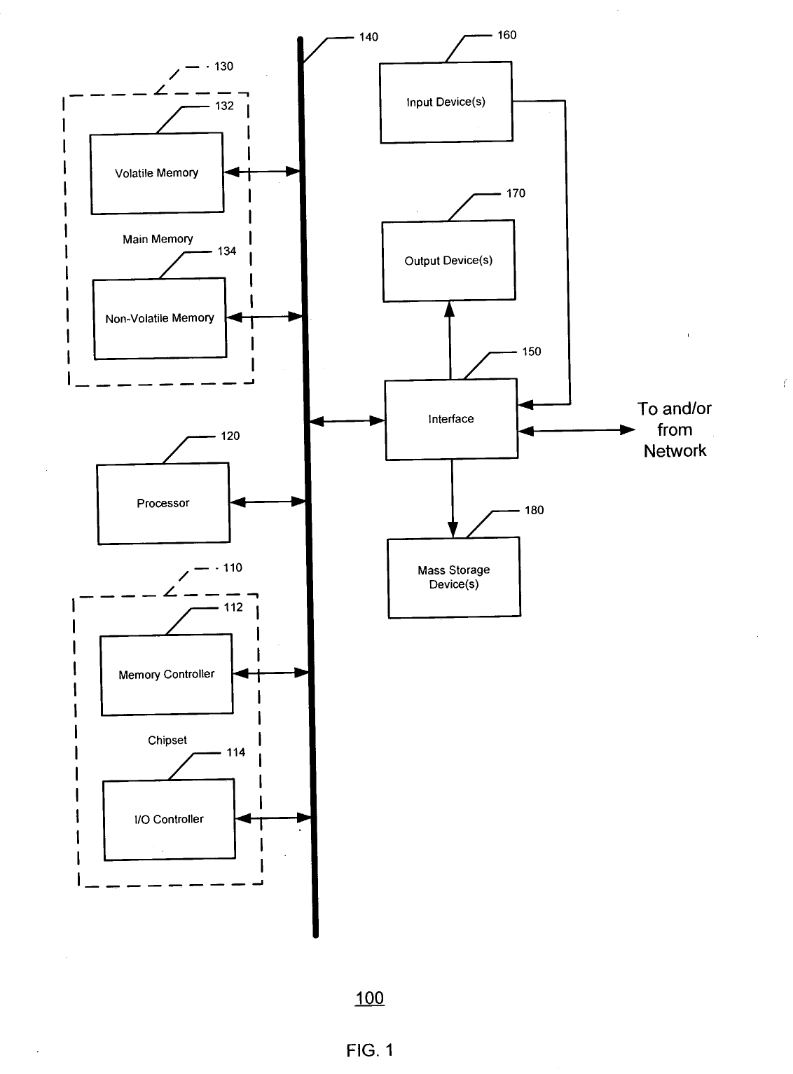

FIG. 1 is a block diagram of an example processor system 100 adapted to implement the methods and apparatus disclosed herein. The processor system 100 may be a desktop computer, a laptop computer, a notebook computer, a personal digital assistant (PDA), a server, an Internet appliance or any other type of computing device.

The processor system 100 illustrated in FIG. 1 includes a chipset 110, which includes a memory controller 112 and an input/output (I/O) controller 114. As is well known, a chipset typically provides memory and I/O management functions, as well as a plurality of general purpose and/or special purpose registers, timers, etc. that are accessible or used by a processor 120. The processor 120 is implemented using one or more in-order processors. For example, the processor 120 may be implemented using one or more of the Intel® Pentium® family of microprocessors, the Intel® Itanium® family of microprocessors, Intel® Centrino® family of microprocessors, and/or the Intel XScale® family of processors. In the alternative, other processors or families of processors may be used to implement the processor 120.

As is conventional, the memory controller 112 performs functions that enable the processor 120 to access and communicate with a main memory 130 including a volatile memory 132 and a non-volatile memory 134 via a bus 140. The volatile memory 132 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 134 may be implemented using flash memory, Read Only Memory (ROM), Electrically Erasable Programmable Read Only Memory (EEPROM), and/or any other desired type of memory device.

The processor system 100 also includes a conventional interface circuit 150 that is coupled to the bus 140. The interface circuit 150 may be implemented using any type of well known interface standard such as an Ethernet interface, a universal serial bus (USB), a third generation input/output interface (3GIO) interface, and/or any other suitable type of interface.

One or more input devices 160 are connected to the interface circuit 150. The input device(s) 160 permit a user to enter data and commands into the processor 120. For example, the input device(s) 160 may be implemented by a keyboard, a mouse, a touch-sensitive display, a track pad, a track ball, an isopoint, and/or a voice recognition system.

One or more output devices 170 are also connected to the interface circuit 150. For example, the output device(s) 170 may be implemented by display devices (e.g., a light emitting display (LED), a liquid crystal display (LCD), a cathode ray tube (CRT) display, a printer and/or speakers). The interface circuit 150, thus, typically includes, among other things, a graphics driver card.

The processor system 100 also includes one or more mass storage devices 180 configured to store software and data. Examples of such mass storage device(s) 180 include floppy disks and drives, hard disk drives, compact disks and drives, and digital versatile disks (DVD) and drives.

The interface circuit 150 also includes a communication device such as a modem or a network interface card to facilitate exchange of data with external computers via a network. The communication link between the processor system 100 and the network may be any type of network connection such as an Ethernet connection, a digital subscriber line (DSL), a telephone line, a cellular telephone system, a coaxial cable, etc.

Access to the input device(s) 160, the output device(s) 170, the mass storage device(s) 180 and/or the network is typically controlled by the I/O controller 114 in a conventional manner. In particular, the I/O controller 114 performs functions that enable the processor 120 to communicate with the input device(s) 160, the output device(s) 170, the mass storage device(s) 180 and/or the network via the bus 140 and the interface circuit 150.

While the components shown in FIG. 1 are depicted as separate functional blocks within the processor system 100, the functions performed by some of these blocks may be integrated within a single semiconductor circuit or may be implemented using two or more separate integrated circuits. For example, although the memory controller 112 and the I/O controller 114 are depicted as separate functional blocks within the chipset 110, persons of ordinary skill in the art will readily appreciate that the memory controller 112 and the I/O controller 114 may be integrated within a single semiconductor circuit.

Prior to loading a full operating system (OS) having a graphical user interface (e.g., Microsoft Windows®), most computers are capable of presenting a text-based user interface in a pre-boot environment (i.e., before an OS is loaded). For example, most DOS-based systems enter a text-based environment if the F2 key is pressed during start up. Typically, instructions and data used to generate this text-based interface are stored in a flash memory device (e.g., the non-volatile memory 140). To enable narrow and wide glyph support in the text-based interface, a string may be embedded with wide and/or narrow directives associated with characters of the string.

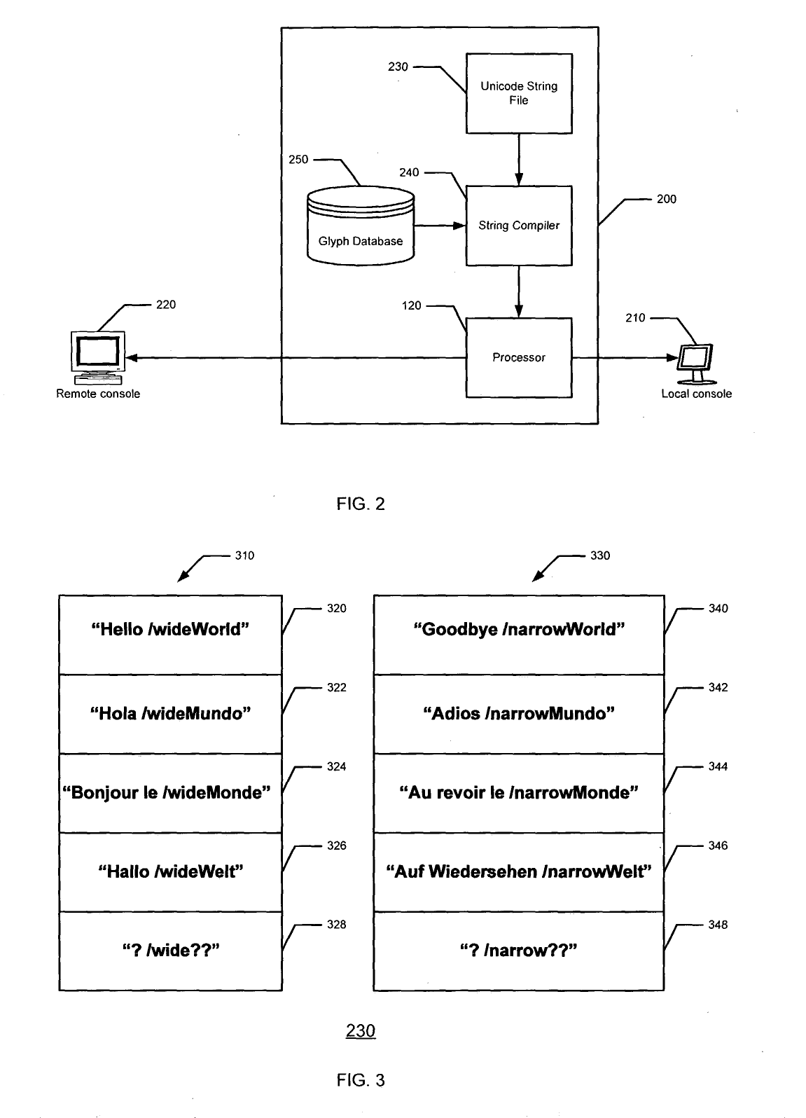

As noted above, the processor 120 is coupled to one or more output devices 170, such as display screens. In the example of FIG. 2, the processor system 200 includes the processor 120. For example, the processor system 200 may be the processor system 100 shown in FIG. 1 and/or any other suitable processor system. In particular, the processor 120 is coupled to a local console 210 and a remote console 220. Although the processor 120 is coupled to one local console and one remote console as shown in FIG. 2, persons of ordinary skill in the art will readily recognize that the processor 120 may be coupled to other local consoles and/or remote consoles. The processor 120 is configured to process a Unicode string file 230 using a string compiler 240 and a glyph database 250. As described in the detail below, the Unicode string file 230 may be stored in the main memory 130, the mass storage device 180, and/or the network. The string compiler 240 may be implemented by the processor 120, and the glyph database 250 may be stored in the main memory 130, the mass storage device 180, and/or the network.

The processor 120 may display the strings of data in the Unicode string file 230 on the local console 210 and/or the remote console 220. For example, the local console 120 may be a display connected to the processor 120 in a conventional manner. The remote console 220 may be a workstation and/or a processor system similar to the processor system 100. Further, the remote console 220 may include its glyph database (not shown). Using telnet, for example, the remote console 220 may access the processor system 100. Persons of ordinary skill in the art will readily recognize that telnet is a user command and an underlying Transmission Control Protocol/Internet Protocol (TCP/IP) protocol for accessing a computer from a remote location. On the Web, Hypertext Transfer Protocol (HTTP) and File Transfer Protocol (FTP) allow a user to request specific files from remote computers, but not to actually be logged on as a user of that computer. With telnet, a user logs on as a regular user with whatever privileges the user may have been granted to the specific application and data on the processor system 100.

Some languages, such as non-Latin based languages may include characters that vary in width. To ensure that a proportional look of such characters is displayed, the Unicode string file 230 includes strings of data encoded with glyph information to display the proper appearance or form of the characters in the strings of data. That is, the strings of data may include wide and/or narrow directives to indicate the wide or narrow versions of characters in the strings of data are to be displayed. Referring to FIG. 3, for example, the Unicode string file 230 may include the string “Hello World” 310 in one or more languages, such as English 320, Spanish 322, French 324, German 326, and Chinese 328. In particular, the string “Hello World” 310 includes a wide directive (i.e., “/wide”) so that the wide version of the word “World” is displayed. In another example shown in FIG. 3, the Unicode string file 230 may include the string “Goodbye World” 330 in one or more languages, such as English 340, Spanish 342, French 344, German 346, and Chinese 348. The string “Goodbye World” 330 includes a narrow directive (i.e., “/narrow”) so that the narrow version of the word “World” is displayed. Although the strings are compiled in an “on-the-fly” fashion by the string compiler 240 as described above, the strings in the Unicode string file 230 may be compiled by the string compiler 240 during the creation of the firmware image as persons of ordinary skill in the art will readily recognize.

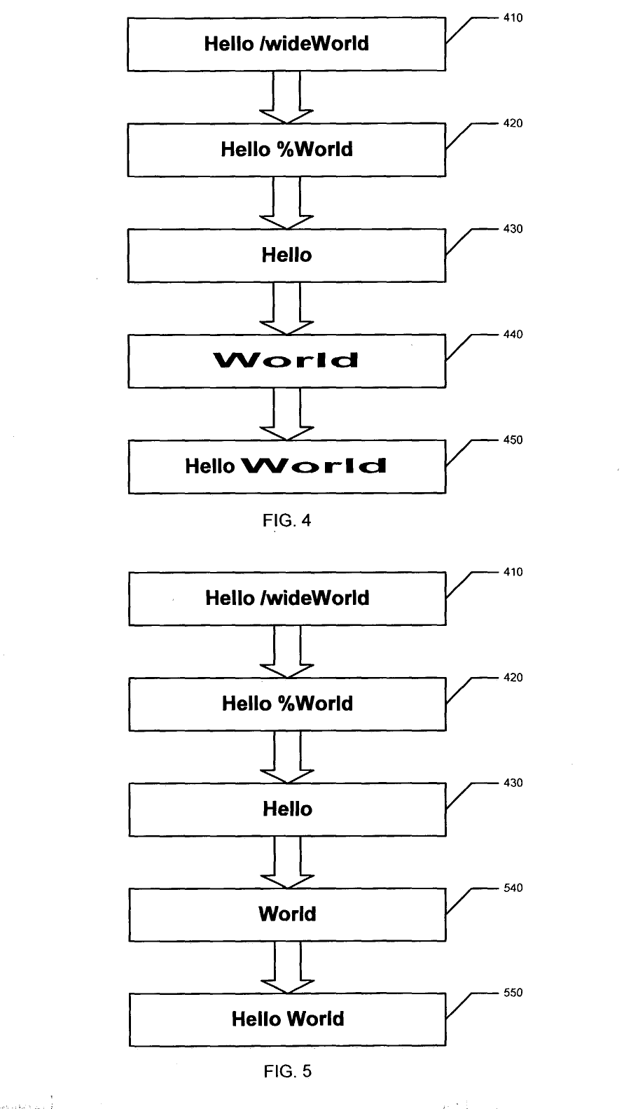

To display characters in the string, the string compiler 240 converts the wide and/or narrow directives in the string to Unicode characters. A set of specific Unicode characters, which are not defined as a part of the Unicode standard, may be used to designate two display behaviors: (1) wide version, and (2) narrow version. In particular, the Unicode standard defines a set of Unicode characters for “Private Use Area” with values of 0xE000 to 0xF8FF. If a Unicode character has a value within the range of 0xE000 to 0xF8FF, then that Unicode character has no specific meaning to be visually translatable. Referring to FIG. 4, for example, the string compiler 240 may convert the wide directive (i.e., “/wide) of the string “Hello/wideWorld” 410 into a Unicode character designated to be undefined for display on the local console 210. That is, the string compiler 240 may convert the “wide” directive into, for example, the Unicode character “%” with a value within the range of 0xE000 to 0xF8FF. Because the Unicode character “%” has a value within that range, the Unicode character “%” may serve as a glyph indicator as described in detail below. After the string compiler 240 processes the Unicode string file 230, the string becomes “Hello % World” 420. Displaying a random character (i.e., “%”) in front of the word “World” on the local console 210 may be meaningless and undesirable. Thus, the processor 120 processes the glyph indicator prior to displaying the string on the local console 210.

To illustrate this concept, the processor 120 begins by drawing each character in the string “Hello % World” 420 for display on the local console 210. As a default, the processor 120 may be configured to draw the narrow version of all characters in the string “Hello % World” 420. In particular, the processor 120 retrieves glyphs from the glyph database 250 to draw the characters in the string “Hello % World” 420. For example, the glyph database 250 may include a plurality of bitmaps corresponding to wide and/or narrow glyphs of characters. Accordingly, the processor 120 retrieves the bitmap corresponding to each character of the word “Hello” 430 (i.e., narrow glyphs of “Hello” 430). Upon detecting the glyph indicator “%”, the processor 120 removes the glyph indicator “%” and begins to retrieve wide glyphs of each character following the glyph indicator “%” in the string “Hello % World” 420 from the glyph database 250 until another glyph indicator is detected. That is, the glyph indicator “%” serves as a delimiter (i.e., a character identifying the beginning or the end of a string), and the processor 120 retrieves the wide glyph of the character “W” in the word “World” 440 from the glyph database 250. The processor 120 continues to retrieve the wide glyphs of the rest of the characters in the word “World” 440 (i.e., “orld”) from the glyph database 250. After retrieving the glyph for each character of the word “World” 440 from the glyph database 250, the processor 120 displays the string “Hello World” 450 with a narrow version of “Hello” and a wide version of “World” on the local console 210.

Alternatively, the glyph indicator “%” is removed without being processed to display the string “Hello % World” 420 on the remote console 220 because the remote console 220 may be incompatible with the wide and/or narrow directives embedded in the string of the Unicode string file 230. In the example of FIG. 5, the string “Hello/wideWorld” 410 is processed for display on the remote console 220. The string compiler 240 converts the string “Hello % World” 420 as described above (i.e., same as if the string “Hello/wideWorld” 410 is displayed on the local console 210). The word “Hello” 430 is also processed by the processor 120 as described above. In contrast to processing the string “% World” for the local console 210, the glyph indicator “%” is removed from the string “Hello % World” 420 without being processed by processor 120 for display of the string “Hello % World” 420 on the remote console 220. Because the glyph indicator “%” may be incompatible with the remote console 220, the processor 120 strips the glyph indicator “%” from the string “Hello % World” 420 prior to transmitting the string “Hello % World” 420 to the remote console 220 for display. As noted above, the remote console 220 may include its own string compiler to convert the string, and its own processor to retrieve the narrow glyphs of the word “Hello” 430 and the word “World” 540 from its glyph database. Thus, the remote console 220 displays the string “Hello World” 550 with narrow versions of both “Hello” and “World” because the glyph indicator “%” is removed.

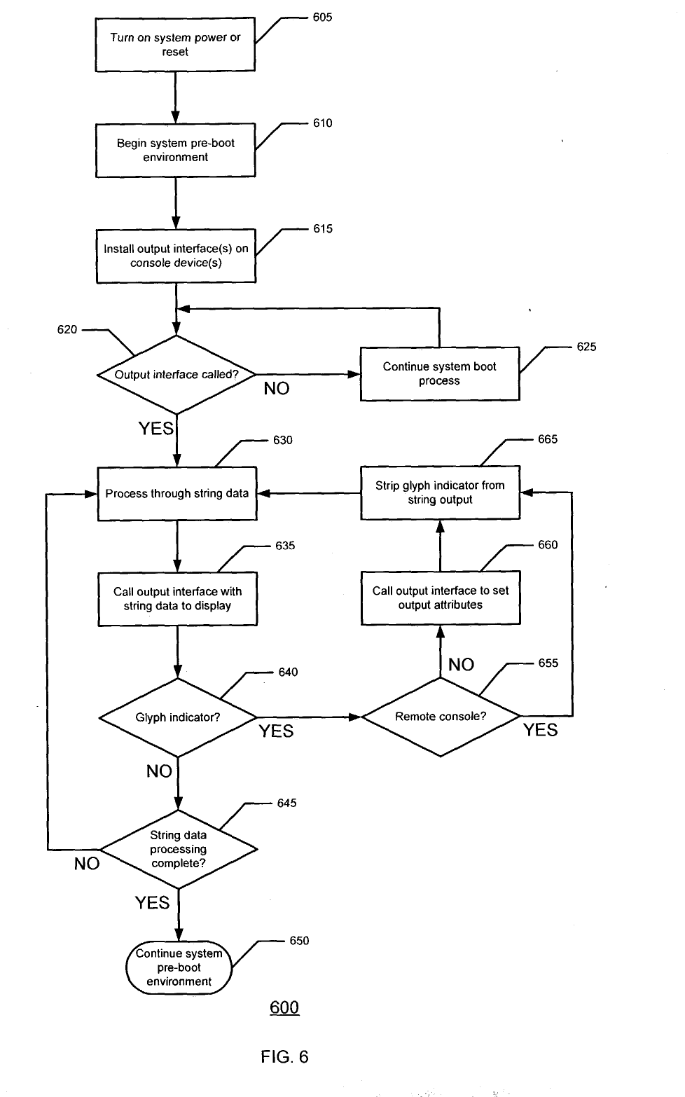

Machine readable instructions that may be executed by the processor system 100 (e.g., via the processor 120) are illustrated in FIG. 6. Persons of ordinary skill in the art will appreciate that the instructions can be implemented in any of many different ways utilizing any of many different programming codes stored on any of many computer-readable mediums such as a volatile or nonvolatile memory or other mass storage device (e.g., a floppy disk, a CD, and a DVD). For example, the machine readable instructions may be embodied in a machine-readable medium such as a programmable gate array, an application specific integrated circuit (ASIC), an erasable programmable read only memory (EPROM), a read only memory (ROM), a random access memory (RAM), a magnetic media, an optical media, and/or any other suitable type of medium. Further, although a particular order of steps is illustrated in FIG. 6, persons of ordinary skill in the art will appreciate that these steps can be performed in other temporal sequences. Again, the flow chart 600 is merely provided as an example of one way to program the processor system 100 to control display attributes of characters in a pre-boot environment.

In the example of FIG. 6, the illustrated process 600 begins with the processor system 100 entering into a pre-boot environment. The pre-boot environment is an environment in which an intended OS, such as Microsoft Windows® is not yet running. In the pre-boot environment, drivers may be loaded that enable a user to obtain and change settings for particular devices. The pre-boot environment has limited resources and, therefore, interfaces provided by drivers for the motherboard and the peripherals may be less user friendly and are usually unfamiliar to most users in contrast to the runtime environment provided after an OS is operating (e.g., a Windows® environment).

Entering the pre-boot environment may be initiated by, for example, applying power to the processor system 100 (block 605). As is known to those having ordinary skill in the art, upon receiving power, the processor 120 experiences a reset condition that causes the processor 120 to execute instructions located in a boot block of the non-volatile memory 134 (e.g., a flash memory) via a reset vector in the processor 120. The instructions in the boot block impart functionality to the processor 120 and inform the processor 120 of the location of further firmware instructions to be executed by the processor 120. The firmware instructions executed by the processor 120 may be stored in the non-volatile memory 134 (e.g., a flash memory), the mass storage device 180 (e.g., a hard drive), and/or any other memory device.

Next, the processor 120 performs initialization tasks, such as testing memories, enumerating buses, etc. (block 610). The processor 120 installs output interfaces on all console devices, such as a display screen (block 615). For example, in an extensible firmware interface (EFI), a SimpleTextOut may be installed to control text-based output devices. In legacy firmware as another example, an INT 10h interface may be installed. The processor 120 then determines if an output interface of a console device is called to display a string (block 620). If an output interface is not called then the processor 120 continues with the boot process (block 625). On the other hand, if an output interface is called, the processor 120 begins string operation by processing through strings of data in a string file (e.g., the Unicode string file 230) (block 630).

The processor 120 then calls the output interface to display a string (block 635). Based on its current attributes, the output interface pulls glyphs of characters of the string from the glyph database 250. As a default, for example, the output interface may be configured to display narrow glyphs of characters. The processor 120 then determines whether the string includes a glyph indicator (block 640). If the processor 120 did not encounter a glyph indicator, the processor 120 determines whether processing of the strings of data is complete (block 645). If processing of the strings of data is complete, the processor 120 continues with the boot process (block 650). Otherwise, the processor 120 returns to block 630 to continue processing of the strings of data.

Returning to block 640, if the processor 120 encounters a glyph indicator, the processor 120 determines whether the console device is either a local console or a remote console (block 655). If the console device is a local console then the processor 120 calls the output interface to set the output attribute to use either the wide glyph or the narrow glyph corresponding to the characters of the string based on the glyph indicator (block 660). Accordingly, the processor 120 continues to use a particular type of glyph until the output attribute is changed. For example, the processor 120 may continue to retrieve wide glyphs of characters after detecting a glyph indicator corresponding to wide glyphs until the processor 120 encounters a glyph indicator corresponding to narrow glyphs. The processor 120 then strips the glyph indicator from the string (block 665) and returns to block 630. As a result, the string may be displayed so that characters with either narrow or wide glyph representations may be differentiated.

Alternatively, the processor 120 determines that the console device is a remote console then the processor 120 proceeds to block 665 to strip the glyph indicator from the string and returns to block 630. That is, the processor 120 removes the glyph indicator without processing the glyph indicator when the console device is a remote console. By removing the glyph indicator, the processor 120 ensures that the string is compatible with the remote console.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A method for controlling display attributes of characters comprising:
retrieving a glyph associated with a character of a string based on glyph information embedded in the string for displaying the character on a local console;
displaying the glyph of the character on the local console; and
removing the glyph information from the string prior to transmitting the string to a remote console for displaying the string on the remote console.

2. A method as defined in claim 1, wherein retrieving the glyph associated with the character comprises retrieving a bitmap associated with the character based on a glyph indicator embedded in the string.

3. A method as defined in claim 1, wherein retrieving the glyph associated with the character comprises retrieving the glyph associated with the character based on a Unicode character indicative of one of a wide directive and a narrow directive.

4. A method as defined in claim 1, wherein displaying the glyph on the local console comprises displaying a narrow character on the local console in response to detecting a Unicode character designated as a narrow glyph indicator.

5. A method as defined in claim 1, wherein displaying the glyph on the local console comprises displaying a wide character on the local console in response to detecting a Unicode character designated as a wide glyph indicator.

6. A method as defined in claim 1, wherein displaying the glyph on the local console comprises displaying a bitmap corresponding to the character based on a glyph indicator.

7. A method as defined in claim 1, wherein removing the glyph information from the string prior to transmitting the string to the remote console for displaying the string on the remote console comprises removing a glyph indicator from the string prior to transmitting the string to the remote console for displaying the string on the remote console.

8. A method as defined in claim 1, wherein one or more of retrieving the glyph associated with the character, displaying the glyph on the local console, and removing the glyph information from the string prior to transmitting the string to the remote console is performed in a pre-boot environment.

9. A method for controlling display attributes of characters comprising:
embedding a glyph indicator into a string;
generating a character of the string on a local console based on the glyph indicator; and
removing the glyph indicator prior to transmitting the string to a remote console for generating the string on the remote console.

10. A method as defined in claim 9, wherein embedding the glyph indicator into the string comprises embedding a Unicode character indicative of one of a wide directive and a narrow directive into the string.

11. A method as defined in claim 9, wherein generating the character of the string on the local console based on the glyph indicator comprises retrieving a bitmap of the character from a database based on the glyph indicator and displaying the bitmap of the character on the local console.

12. A method as defined in claim 9, wherein one or more of embedding the glyph indicator into the string, generating the character of the string on the local console, and removing the glyph indicator prior to transmitting the string to the remote console is performed in a pre-boot environment.

13. A machine readable medium storing instructions, which when executed, cause a machine to:
retrieve a glyph associated with a character of a string based on glyph information embedded in the string for displaying the character on a local console;
display the glyph of the character on the local console; and
remove the glyph information from the string prior to transmitting the string to a remote console for displaying the string on the remote console.

14. A machine readable medium as defined in claim 13, wherein the instructions cause the machine to retrieve the glyph associated with the character by retrieving a bitmap associated with the character based on a glyph indicator embedded in the string.

15. A machine readable medium as defined in claim 13, wherein the instructions cause the machine to retrieve glyph information associated with a character by retrieving the glyph associated with the character based on a Unicode character indicative of one of a wide directive and a narrow directive.

16. A machine readable medium as defined in claim 13, wherein the instructions cause the machine to display the glyph of the character on the local console by displaying a narrow character on the local console in response to detecting a Unicode character designated as a narrow glyph indicator.

17. A machine readable medium as defined in claim 13, wherein the instructions cause the machine to display the glyph of the character on the local console by displaying a wide character on the local console in response to detecting a Unicode character designated as a wide glyph indicator.

18. A machine readable medium as defined in claim 13, wherein the instructions cause the machine to display the glyph of the character on the local console by displaying a bitmap corresponding to the character based on a glyph indicator.

19. A machine readable medium as defined in claim 13, wherein the instructions cause the machine to remove the glyph information from the string prior to transmitting the string to a remote console for displaying the string on the remote console by removing a glyph indicator from the string prior to transmitting the string to the remote console for displaying the string on the remote console.

20. A machine readable medium as defined in claim 13, wherein one or more of the instructions that cause the machine to retrieve the glyph associated with the character of the string, to display the glyph of the character on the local console, and to remove the glyph information from the string prior to transmitting the string to the remote console is performed in a pre-boot environment.

21. A machine readable medium as defined in claim 13, wherein the machine readable medium comprises one of a programmable gate array, application specific integrated circuit, erasable programmable read only memory, read only memory, random access memory, magnetic media, and optical media.

22. An apparatus to control display attributes of characters, the apparatus comprising:
a data structure configured to store at least one glyph associated with a character;
a processor operatively coupled to the data structure, the processor being programmed to monitor for a glyph indicator in a string, to retrieve the at least one glyph from the data structure based on the glyph indicator in response to detecting a local console, and to remove the glyph indicator from the string prior to transmitting the string to a remote console in response to detecting a remote console; and
a local output interface operatively coupled to the processor, the local output interface being configured to display the at least one glyph.

23. An apparatus as defined in claim 22, wherein the at least one glyph comprises a bitmap.

24. An apparatus as defined in claim 22, wherein the glyph indicator comprises one of a narrow glyph indicator and a wide glyph indicator.

25. An apparatus as defined in claim 22, wherein the glyph indicator comprises a Unicode character designated as one of a narrow glyph indicator and a wide glyph indicator.

26. An apparatus as defined in claim 22, wherein one or more of the data structure, the processor, and the local output interface is configured to operate in a pre-boot environment.

27. A processor system to control display attributes of characters, the processor system comprising:
a dynamic random access memory (DRAM) configured to store at least one glyph definition associated with a character;
a processor operatively coupled to the data structure, the processor being programmed to monitor for a glyph indicator in a string, to retrieve the at least one glyph from the data structure based on the glyph indicator in response to detecting a local console, and to remove the glyph indicator from the string prior to transmitting the string to a remote console in response to detecting a remote console; and
a local output interface operatively coupled to the processor, the local output interface being configured to display the at least one glyph.

28. A processor system as defined in claim 27, wherein the at least one glyph comprises a bitmap.

29. A processor system as defined in claim 27, wherein the glyph indicator comprises one of a narrow glyph indicator and a wide glyph indicator.

30. A processor system as defined in claim 27, wherein the glyph indicator comprises a Unicode character designated as one of a narrow glyph indicator and a wide glyph indicator.

31. A processor system as defined in claim 27, wherein one or more of the DRAM, the processor, and the local output interface is configured to operate in a pre-boot environment.
